(19) United States
(12) Patent Application Publication
(10) Pub. No.: US 2010/0077553 A1
(43) Pub. Date: Apr. 1, 2010

(54) TOOLS HAVING MARKINGS FOR MEASURING

(75) Inventors: James D. Davidson, St. Charles, IL (US); David Konopka, Parama Heights, OH (US)

Correspondence Address: GREENBERG TRAURIG, LLP, 77 WEST WACKER DRIVE, SUITE 3100, CHICAGO, IL, 60601-1732, US

(73) Assignee: Sears Brands, LLC, Hoffman Estates, IL (US)

(21) Appl. No.: 12/238,831

(22) Filed: Sep. 26, 2008

(51) Int. Cl. B25F 1/00

(52) U.S. Cl. 7/138

(57) ABSTRACT

An embodiment of the present invention is directed to a tool that includes an elongated surface. The elongated surface has a plurality of spaced markings thereon for enabling a user of the tool to measure a length of an object or a depth by comparing the length of the object to the spaced markings.

### BACKGROUND

1. Field

The present invention generally relates to the field of tools.

2. Background

Oftentimes, when a craftsman is working on one or more workpieces, a need arises to take a quick measurement of a dimension or spacing of the workpieces. For example, the craftsman may want to verify the spacing between two pilot holes, or the craftsman may want to verify the size of a screw. To do so typically requires the craftsman to set down the tools he or she is currently using and then take the measurement using a conventional tape measure. This can be inconvenient, especially when the craftsman does not have a tape measure nearby.

Furthermore, some situations are conceivable in which use of a tape measure is simply not desired. For example, one may need to measure a depth through a bundle of wires or other substance that would otherwise resist a tape measure and cause the tape measure to bend and flex. Also, one may need to measure a depth in a space which is simply tool small for a conventional tape measure or straight rule.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

An embodiment of the present invention is directed to a tool that includes an elongated surface. The elongated surface has a plurality of spaced markings thereon for enabling a user of the tool to measure a length of an object or a depth by comparing the length of the object to the spaced markings.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a isometric view of an adjustable wrench, in accordance with an embodiment of the present invention.

FIG. 2 is a first side view of an adjustable wrench, in accordance with an embodiment of the present invention.

FIG. 3 is a second side view of an adjustable wrench, in accordance with an embodiment of the present invention.

FIG. 4 is a top view of an adjustable wrench, in accordance with an embodiment of the present invention.

FIG. 5 is a bottom view of an adjustable wrench, in accordance with an embodiment of the present invention.

FIG. 6 is a distal end view of an adjustable wrench, in accordance with an embodiment of the present invention.

FIG. 7 is a proximate end view of an adjustable wrench, in accordance with an embodiment of the present invention.

FIG. 8 is a isometric view of a ratchet, in accordance with an embodiment of the present invention.

FIG. 9 is a first side view of a ratchet, in accordance with an embodiment of the present invention.

FIG. 10 is a second side view of a ratchet, in accordance with an embodiment of the present invention.

FIG. 11 is a bottom view of a ratchet, in accordance with an embodiment of the present invention.

FIG. 12 is a top view of a ratchet, in accordance with an embodiment of the present invention.

FIG. 13 is a proximate end view of a ratchet, in accordance with an embodiment of the present invention.

FIG. 14 is a distal end view of a ratchet, in accordance with an embodiment of the present invention.

FIG. 15 is a isometric view of an box-end wrench, in accordance with an embodiment of the present invention.

FIG. 16 is a first side view of an box-end wrench, in accordance with an embodiment of the present invention.

FIG. 17 is a second side view of an box-end wrench, in accordance with an embodiment of the present invention.

FIG. 18 is a top view of an box-end wrench, in accordance with an embodiment of the present invention.

FIG. 19 is a bottom view of an box-end wrench, in accordance with an embodiment of the present invention.

FIG. 20 is a first end view of an box-end wrench, in accordance with an embodiment of the present invention.

FIG. 21 is a second end view of an box-end wrench, in accordance with an embodiment of the present invention.

FIG. 22 is a isometric view of a pair of pliers, in accordance with an embodiment of the present invention.

FIG. 23 is a first side view of a pair of pliers, in accordance with an embodiment of the present invention.

FIG. 24 is a second side view of a pair of pliers, in accordance with an embodiment of the present invention.

FIG. 25 is a distal end view of a pair of pliers, in accordance with an embodiment of the present invention.

FIG. 26 is a proximate end view of a pair of pliers, in accordance with an embodiment of the present invention.

FIG. 27 is a top view of a pair of pliers, in accordance with an embodiment of the present invention.

FIG. 28 is a bottom view of a pair of pliers, in accordance with an embodiment of the present invention.

FIG. 29 is a isometric view of a screwdriver, in accordance with an embodiment of the present invention.

FIG. 30 is a first side view of a screwdriver, in accordance with an embodiment of the present invention.

FIG. 31 is a second side view of a screwdriver, in accordance with an embodiment of the present invention.

FIG. 32 is a proximate end view of a screwdriver, in accordance with an embodiment of the present invention.

FIG. 33 is a distal end view of a screwdriver, in accordance with an embodiment of the present invention.

FIG. 34 is a isometric view of a socket, in accordance with an embodiment of the present invention.

FIG. 35 is a first side view of a socket, in accordance with an embodiment of the present invention.

FIG. 36 is a second side view of a socket, in accordance with an embodiment of the present invention.

FIG. 37 is a top view of a socket, in accordance with an embodiment of the present invention.

FIG. 38 is a bottom view of a socket, in accordance with an embodiment of the present invention.

FIG. 39 is a isometric view of a hammer, in accordance with an embodiment of the present invention.

FIG. 40 is a first side view of a hammer, in accordance with an embodiment of the present invention.

FIG. 41 is a second side view of a hammer, in accordance with an embodiment of the present invention.

FIG. 42 is a proximate end view of a hammer, in accordance with an embodiment of the present invention.

FIG. 43 is a distal end view of a hammer, in accordance with an embodiment of the present invention.

FIG. 44 is a bottom view of a hammer, in accordance with an embodiment of the present invention.

FIG. 45 is a top view of a hammer, in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, and components have not been described in detail as not to unnecessarily obscure aspects of the present invention.

### Overview

Generally speaking embodiments provide for tools that are manufactured with graduated markings included thereon, for measuring a dimension and/or spacing of a workpiece or other object. Though not required by the present invention, the graduated markings are preferably located on a long, flat surface of the tool, thereby facilitating easier measurement of the target object. The graduated markings may be spaced in accordance with a standard measurement system, such as the English System or the Metric System. By having graduated markings displayed thereon, tools according to the present invention allow for a craftsman to quickly and easily measure an object, without having to set down the tool he or she is currently using and search for a tape measure. Thus, the craftsman is provided with a time-saving, convenient option for measuring the object. In various embodiments, the marking may begin at an edge of the tool, so as to allow the tool to be used to measure a depth.

Embodiments will now be described with respect to particular implementations for particular tools. While such embodiments are described with respect to specific types of tools, such embodiments are exemplary, and it should be appreciated by one of skill in the art that the present invention is not limited to such embodiments.

### Exemplary Adjustable Wrench

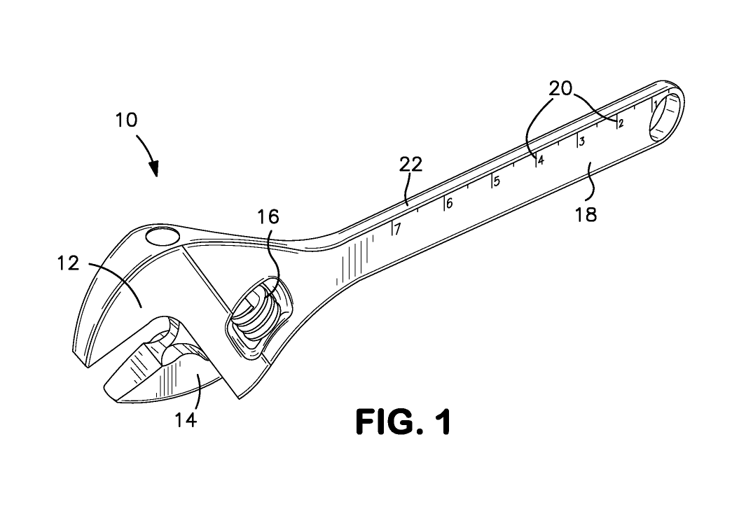

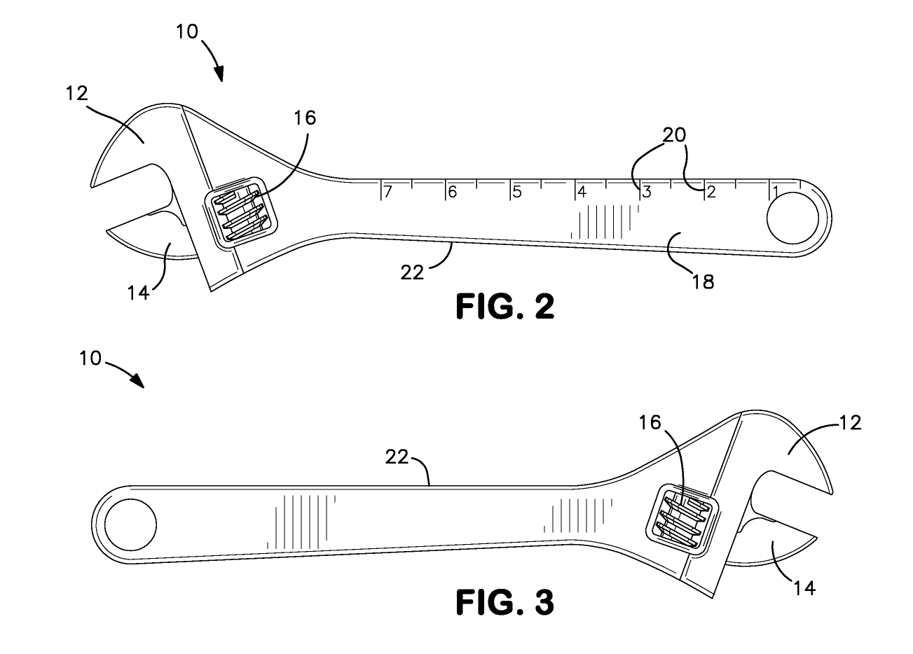

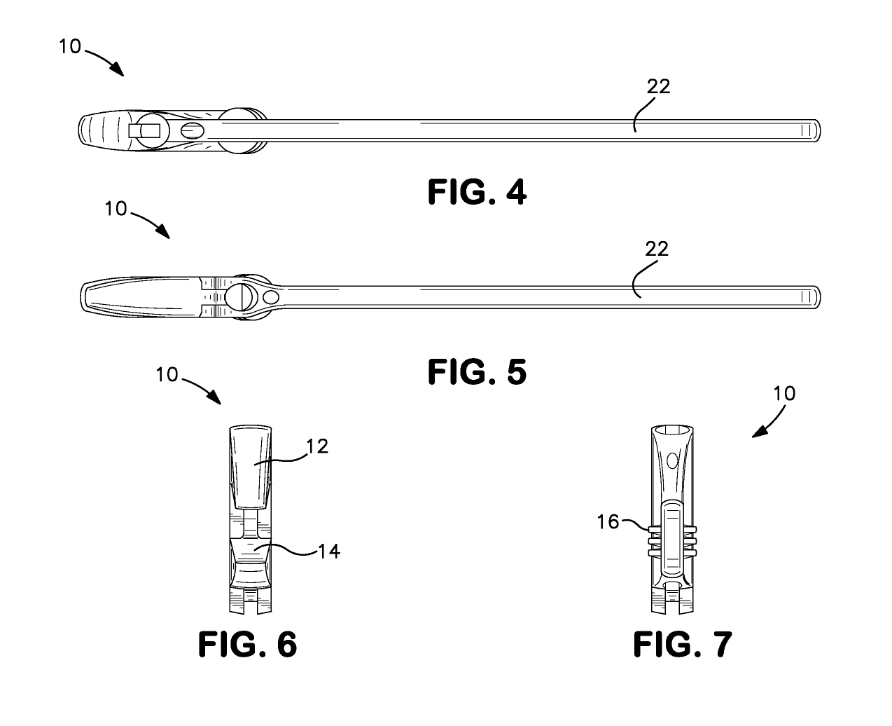

With reference to FIGS. 1-7, an exemplary adjustable wrench 10, in accordance with an embodiment of the present invention, is disclosed. The adjustable wrench 10 includes an operating portion that may further include a fixed jaw 12, a movable jaw 14, and an adjustment screw 16 for adjusting the movable jaw. The adjustable wrench 10 further includes a handle portion 22. The adjustable wrench 10 also includes at least one elongated surface 18, which advantageously includes a plurality of spaced markings 20 provided thereon, for enabling a user of the adjustable wrench 10 to measure a length of an object by comparing the length of the object to the spaced markings 20. In a preferred embodiment, the surface 18 is a surface of the handle portion 22. The markings 20 may be graduated according to a standard measurement system. The markings 20 may further include numerals provided on the elongated surface 18, each associated with a particular marking 20, and corresponding to the standard measurement system. As shown, an imaginary “zero” mark of the markings 20 coincides with the end of the handle portion 22. Thus, the adjustable wrench 10 may be used as either a side-rule or a depth-rule. It should be appreciated that other contemplated configurations are within the spirit and scope of the present invention.

While FIGS. 1-7 show the markings 20 as being provided only on a single surface 18 of the adjustable wrench 10, it should be appreciated that such markings 20 may be provided on a different surface. Moreover, the markings 20 may be provided on multiple surfaces of the adjustable wrench 10.

### Exemplary Ratchet

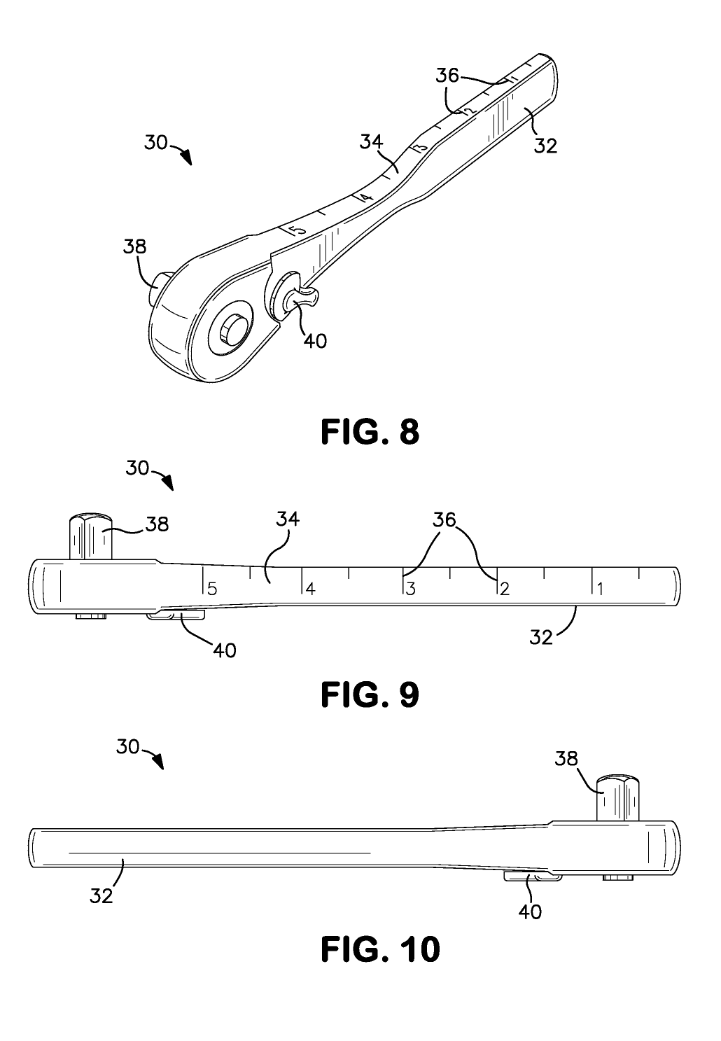

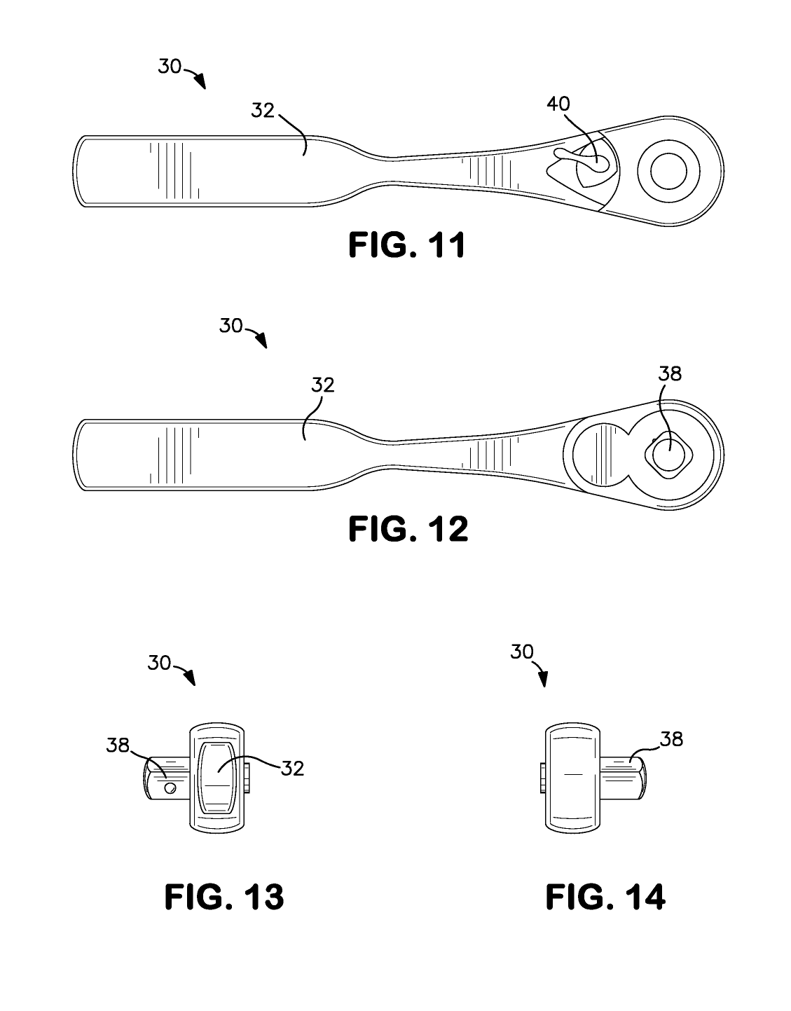

With reference to FIGS. 8-14, an exemplary ratchet 30, in accordance with an embodiment of the present invention, is disclosed. The ratchet 30 includes an operating portion that may further include a socket adapter 38, for coupling with a socket, and a switch 40 for adjusting reversing the rotational operation of the socket adapter 38. The ratchet 30 further includes a handle portion 32. The ratchet 30 also includes at least one elongated surface 34, which advantageously includes a plurality of spaced markings 36 provided thereon, for enabling a user of the ratchet 30 to measure a length of an object by comparing the length of the object to the spaced markings 36. In a preferred embodiment, the surface 34 is a surface of the handle portion 32. The markings 36 may be graduated according to a standard measurement system. The markings 36 may further include numerals provided on the elongated surface 34, each associated with a particular marking 36, and corresponding to the standard measurement system. As shown, an imaginary “zero” mark of the markings 36 coincides with the end of the handle portion 32. Thus, the ratchet 30 may be used as either a side-rule or a depth-rule. It should be appreciated that other contemplated configurations are within the spirit and scope of the present invention.

While FIGS. 8-14 show the markings 36 as being provided only on a single surface 34 of the ratchet 30, it should be appreciated that such markings 36 may be provided on a different surface. Moreover, the markings 36 may be provided on multiple surfaces of the ratchet 30.

### Exemplary Box-End Wrench

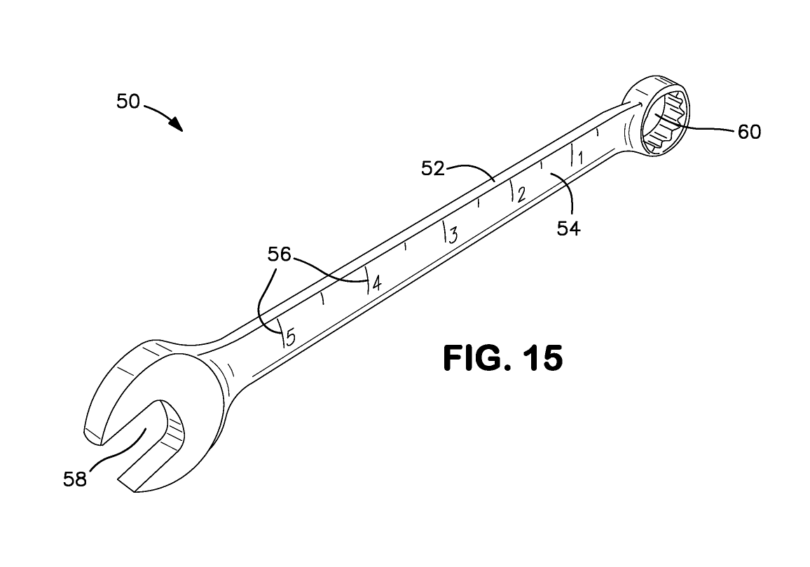

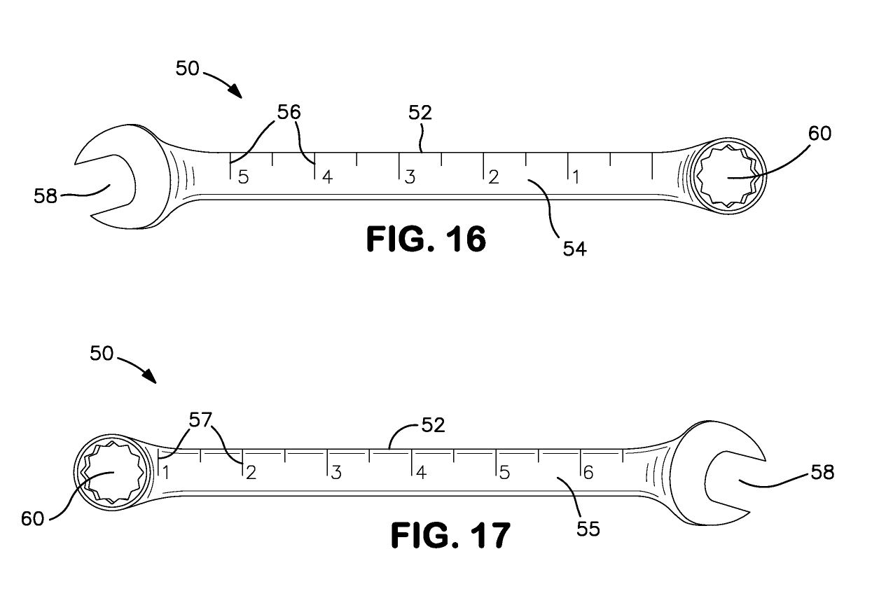

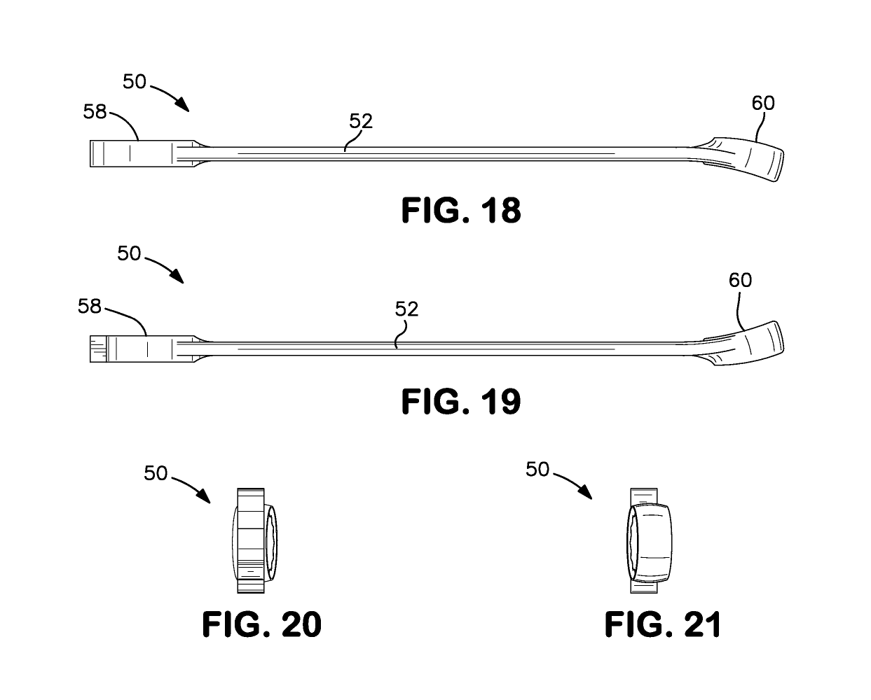

With reference to FIGS. 15-21, an exemplary box-end wrench 50, in accordance with an embodiment of the present invention, is disclosed. The box-end wrench 50 has an open end 58 and a closed end 60 (also known as a box end). The box-end wrench 50 further includes a handle portion 52. The box-end wrench 50 also includes at least one elongated surface 54, which advantageously includes a plurality of spaced markings 56 provided thereon, for enabling a user of the box-end wrench 50 to measure a length of an object by comparing the length of the object to the spaced markings 56. In a preferred embodiment, the surface 54 is a surface of the handle portion 52. The markings 56 may be graduated according to a standard measurement system. The markings 56 may further include numerals provided on the elongated surface 54, each associated with a particular marking 56, and corresponding to the standard measurement system.

As shown in FIGS. 15-21, markings 57 may also be provided on a second elongated surface 55. In the illustrated embodiment, markings 56 are positioned so that box-end wrench 50 may serve as a side-rule, while markings 57 are positioned so that box-end wrench 50 may serve as both a side-rule and a depth-rule. It should be appreciated that other contemplated configurations are within the spirit and scope of the present invention.

### Exemplary Pliers

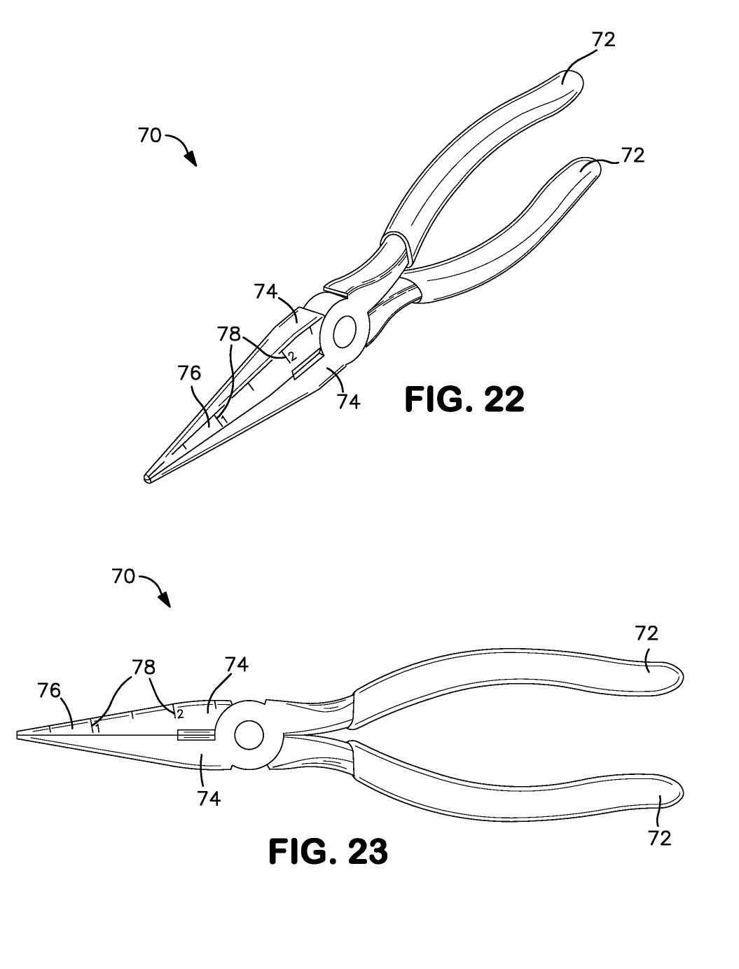

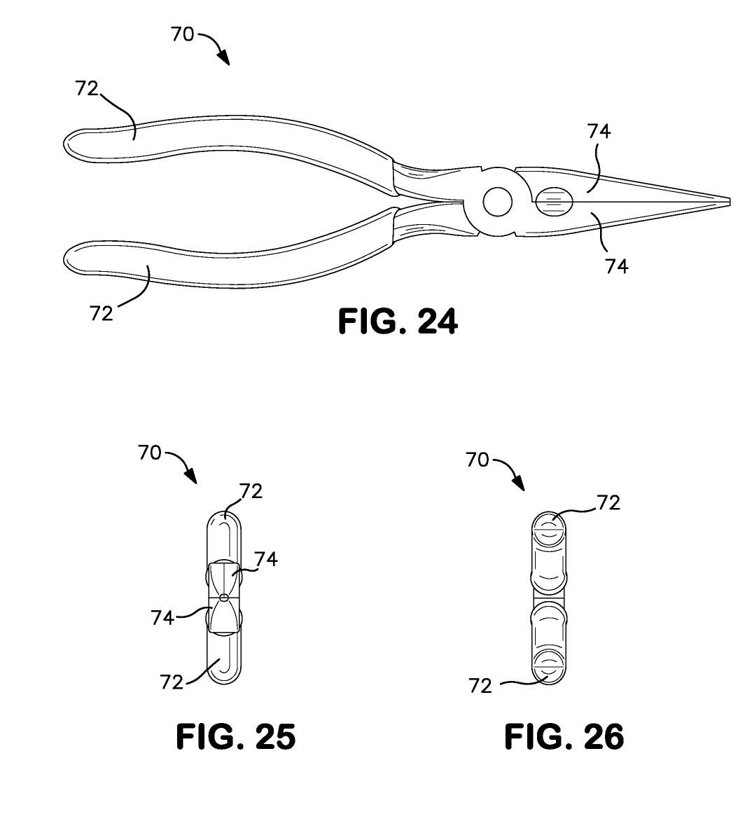

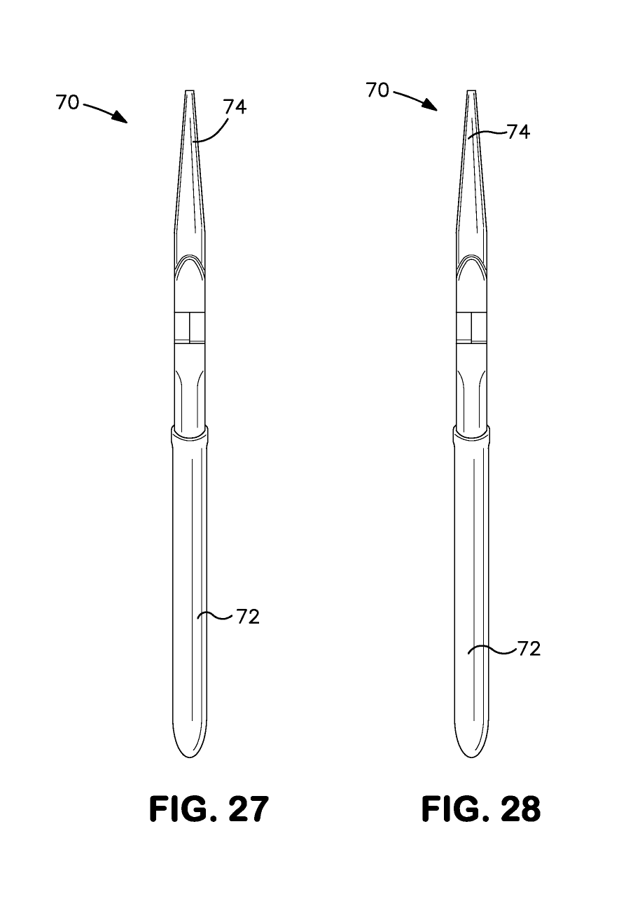

With reference to FIGS. 22-28, exemplary pliers 70, in accordance with an embodiment of the present invention, are disclosed. The pliers 70 include a pair of jaws 74 and a pair of handles 72. The pliers 70 also include at least one elongated surface 76, which advantageously includes a plurality of spaced markings 78 provided thereon, for enabling a user of the pliers 70 to measure a length of an object by comparing the length of the object to the spaced markings 78. In a preferred embodiment, the surface 76 is a surface of at least one of the jaws 74. The markings 78 may be graduated according to a standard measurement system. The markings 78 may further include numerals provided on the elongated surface 76, each associated with a particular marking 78, and corresponding to the standard measurement system. As shown, an imaginary “zero” mark of the markings 78 coincides with the end of the corresponding jaw 74. Thus, the pliers 70 may be used as either a side-rule or a depth-rule. It should be appreciated that other contemplated configurations are within the spirit and scope of the present invention.

While FIGS. 22-28 show the markings 78 as being provided only on a single surface 76 of the pliers 70, it should be appreciated that such markings 78 may be provided on a different surface. Moreover, the markings 20 may be provided on multiple surfaces of the pliers 70.

### Exemplary Screwdriver

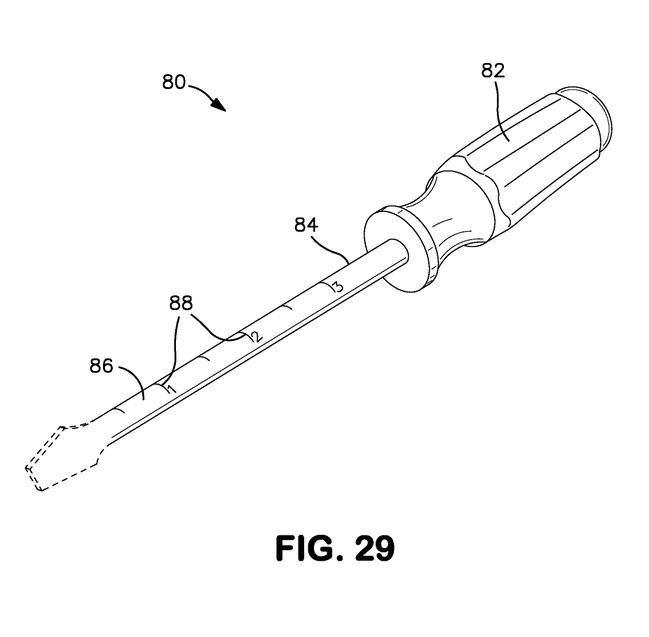

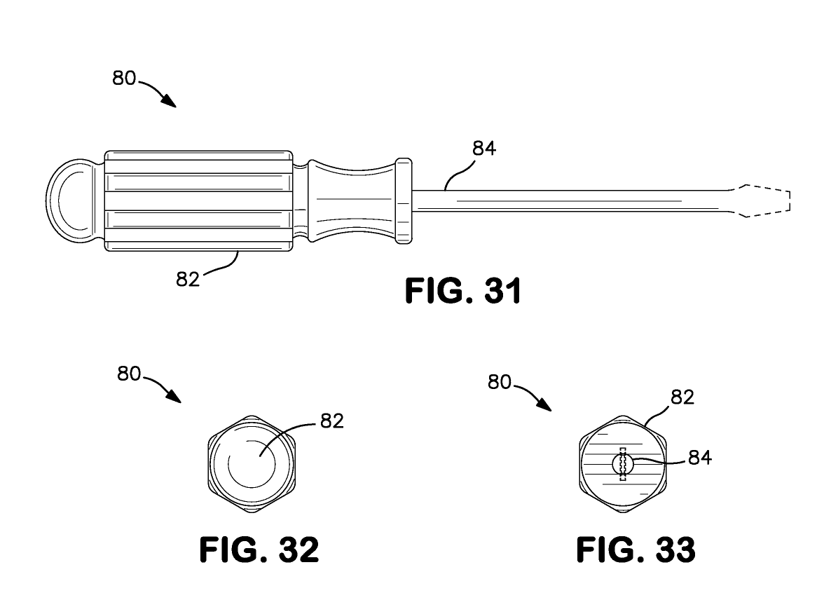

With reference to FIGS. 29-33, an exemplary screwdriver 80, in accordance with an embodiment of the present invention, is disclosed. The screwdriver 80 includes a shaft portion 84 and a handle portion 82. The screwdriver 80 also includes at least one elongated surface 86, which advantageously includes a plurality of spaced markings 88 provided thereon, for enabling a user of the screwdriver 80 to measure a length of an object by comparing the length of the object to the spaced markings 88. In a preferred embodiment, the surface 86 is a surface of the shaft portion 84. The markings 88 may be graduated according to a standard measurement system. The markings 88 may further include numerals provided on the elongated surface 86, each associated with a particular marking 88, and corresponding to the standard measurement system.

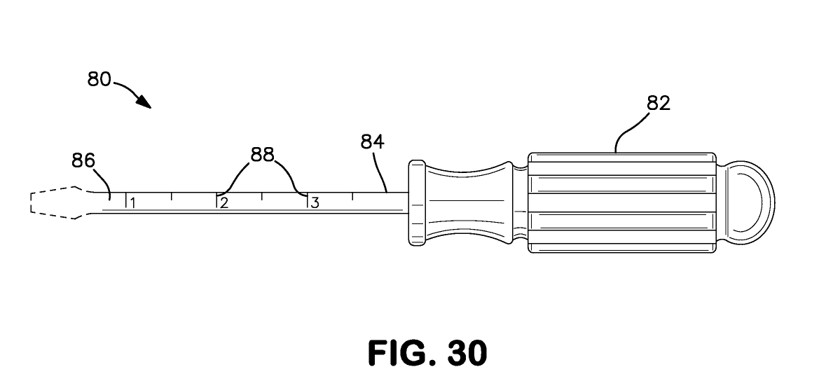

As shown in FIG. 29, markings 88 may be positioned so that screwdriver 80 may serve as a side-rule. As shown in FIG. 30, an imaginary “zero” mark of the markings 88 may also coincide with the end of the handle portion 82. Thus, the screwdriver 80 may also be used as a depth-rule. It should be appreciated that other contemplated configurations are within the spirit and scope of the present invention.

While FIGS. 29-33 show the markings 88 as being provided only on a single surface 86 of the screwdriver 80, it should be appreciated that such markings 88 may be provided on a different surface. Moreover, the markings 20 may be provided on multiple surfaces of the screwdriver 80.

### Exemplary Socket

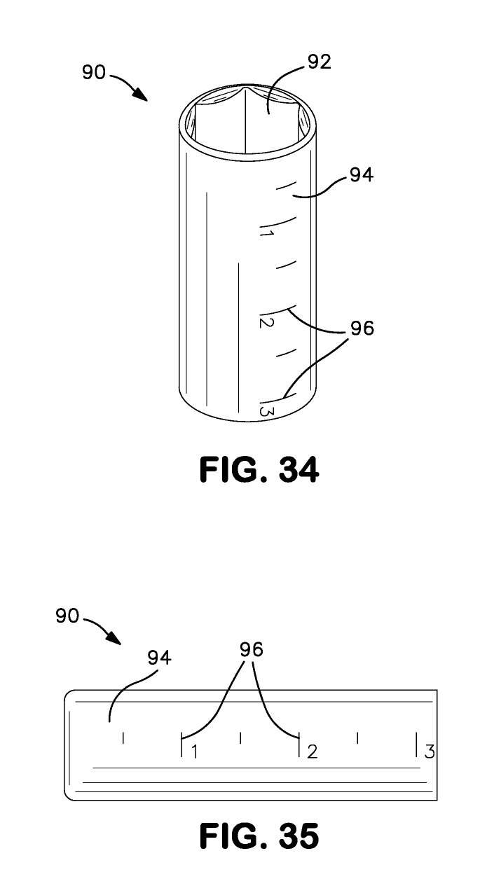

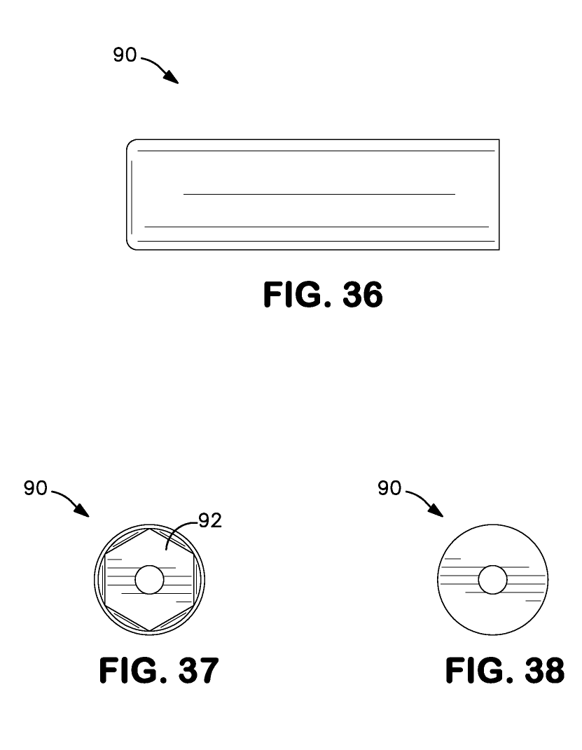

With reference to FIGS. 34-38, an exemplary socket 90, in accordance with an embodiment of the present invention, is disclosed. The socket 90 includes an open end 92, adapted for mating with a nut of a particular size. The socket 90 also includes at least one elongated surface 94, which advantageously includes a plurality of spaced markings 96 provided thereon, for enabling a user of the socket 90 to measure a length of an object by comparing the length of the object to the spaced markings 96. The markings 96 may be graduated according to a standard measurement system. The markings 96 may further include numerals provided on the elongated surface 94, each associated with a particular marking 96, and corresponding to the standard measurement system. As shown, an imaginary “zero” mark of the markings 78 coincides with an end of the socket 90. Thus, the socket 90 may be used as either a side-rule or a depth-rule. It should be appreciated that other contemplated configurations are within the spirit and scope of the present invention.

While FIGS. 34-38 show the markings 96 as being provided only on one portion of surface 94 of the socket 90, it should be appreciated that such markings 96 may be provided on multiple portions of the surface 94.

### Exemplary Hammer

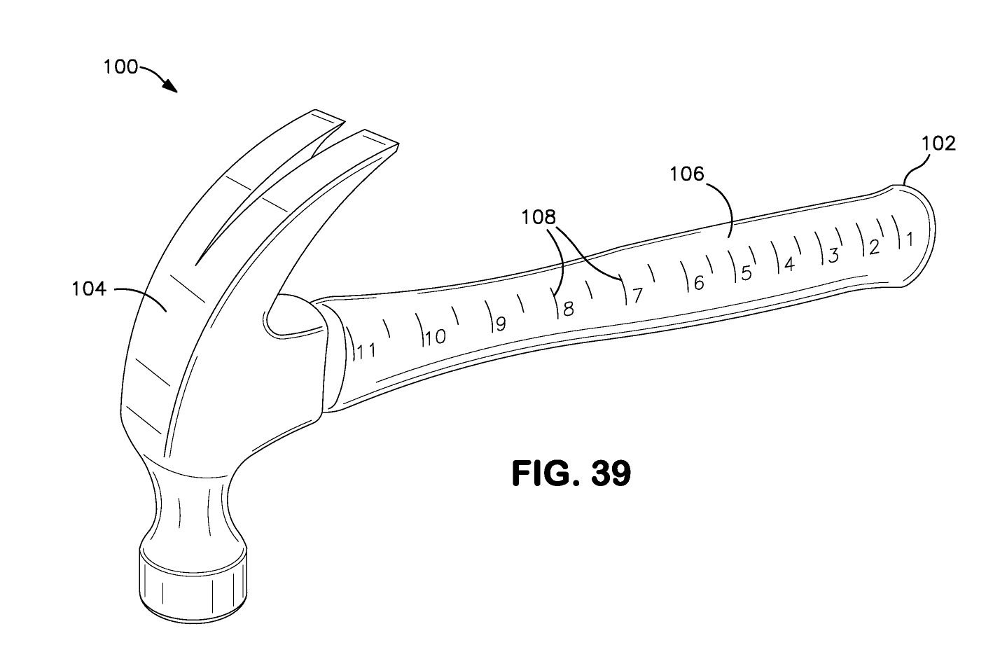

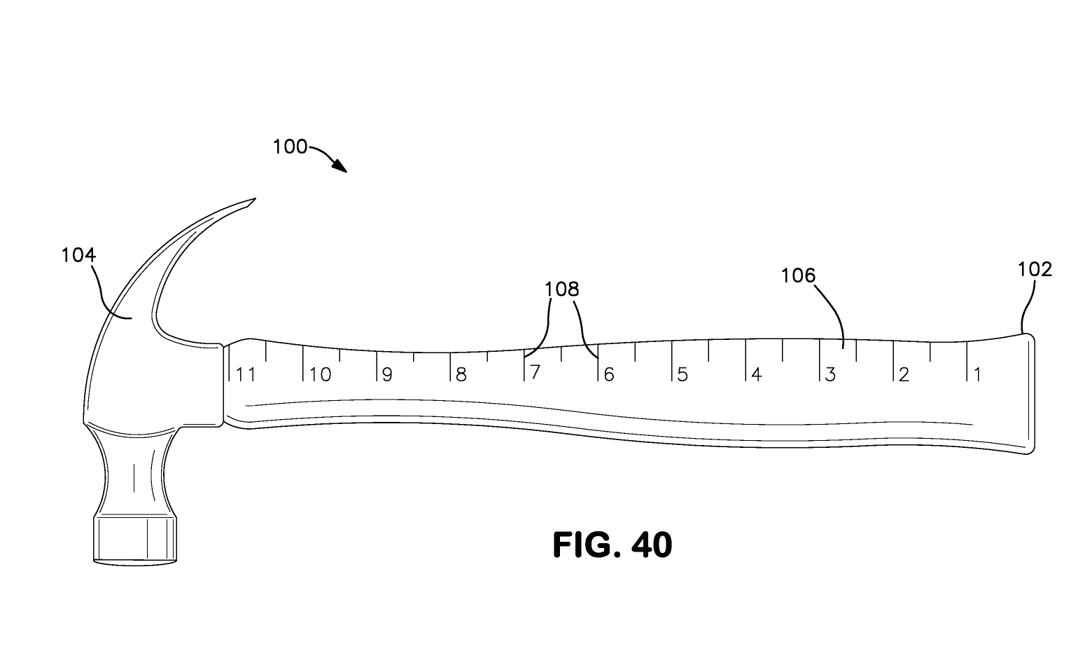

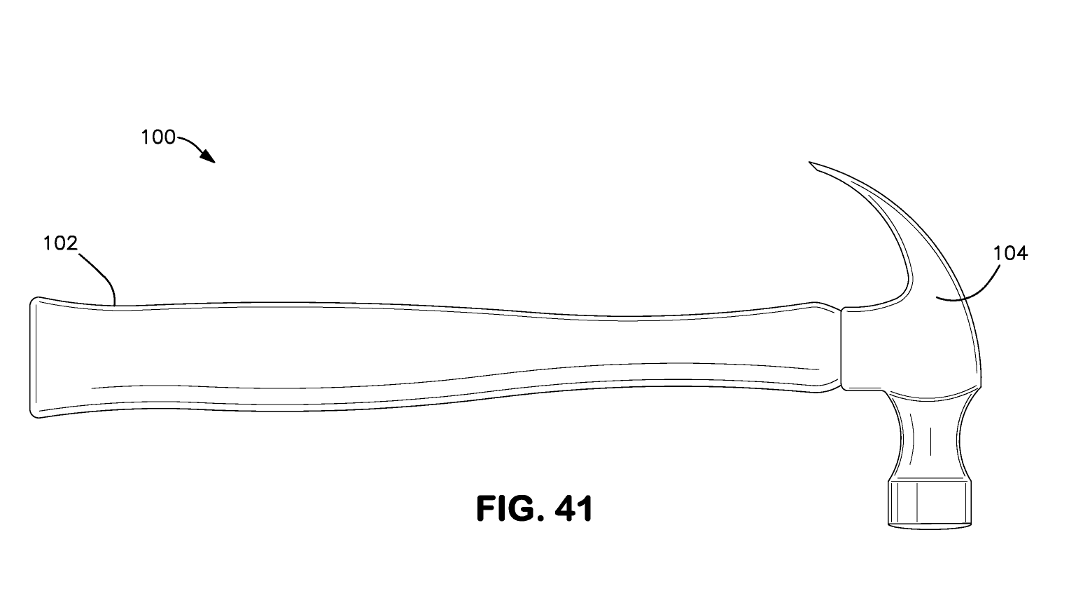

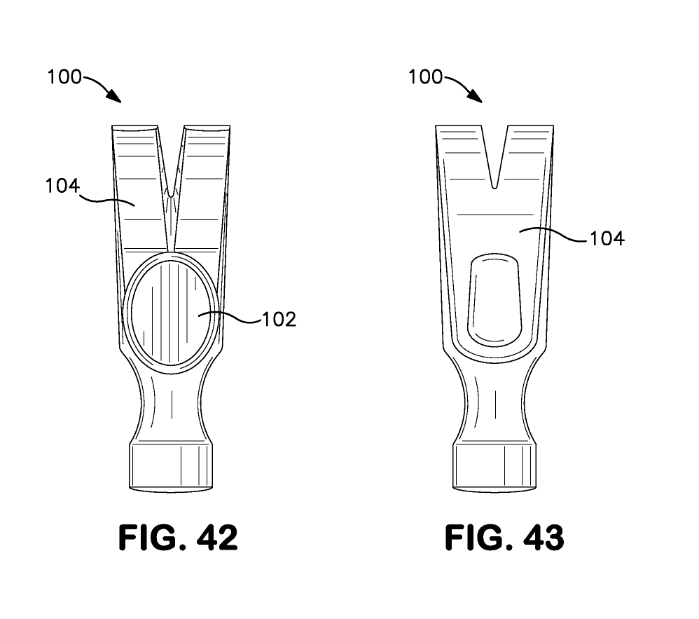

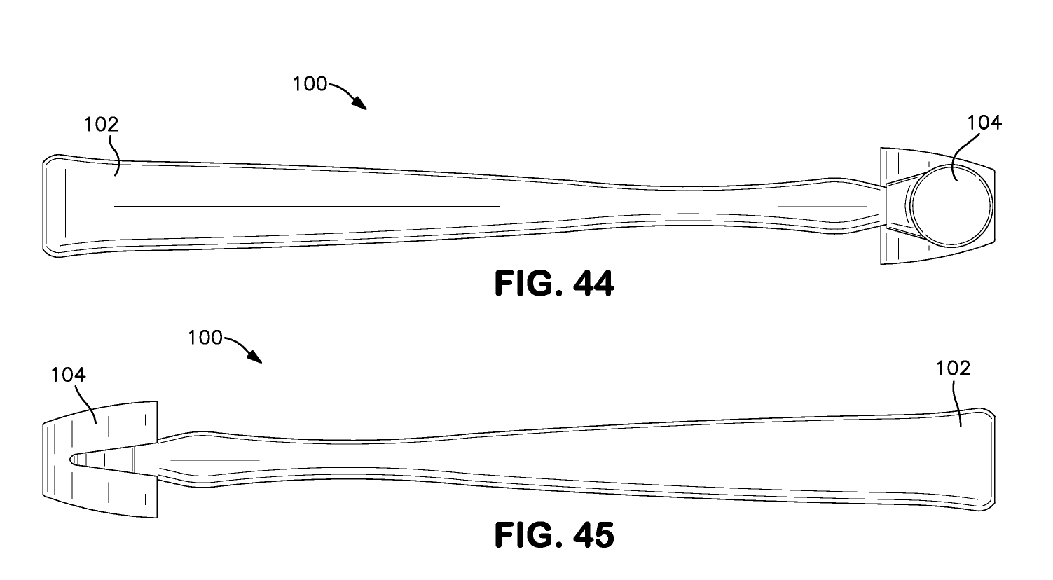

With reference to FIGS. 39-45, an exemplary hammer 100, in accordance with an embodiment of the present invention, is disclosed. The hammer 100 includes an operating portion 104 and a handle portion 102. The hammer 100 also includes at least one elongated surface 106, which advantageously includes a plurality of spaced markings 108 provided thereon, for enabling a user of the hammer 100 to measure a length of an object by comparing the length of the object to the spaced markings 108. In a preferred embodiment, the surface 106 is a surface of the handle portion 102. The markings 108 may be graduated according to a standard measurement system. The markings 108 may further include numerals provided on the elongated surface 106, each associated with a particular marking 108, and corresponding to the standard measurement system. As shown, an imaginary “zero” mark of the markings 108 coincides with the end of the handle portion 102. Thus, the hammer 100 may be used as either a side-rule or a depth-rule. It should be appreciated that other contemplated configurations are within the spirit and scope of the present invention.

While FIGS. 39-45 show the markings 108 as being provided only on a single surface 106 of the hammer 100, it should be appreciated that such markings 108 may be provided on a different surface. Moreover, the markings 108 may be provided on multiple surfaces of the hammer 100.

Thus, various embodiments provide for tools that are manufactured with graduated markings included thereon, for measuring a dimension and/or spacing of a workpiece or other object. By having graduated markings displayed thereon, tools according to the present invention allow for a craftsman to quickly and easily measure an object, without having to set down the tool he or she is currently using and search for a tape measure or other separate measuring device. Thus, the craftsman is provided with a time-saving, convenient option for measuring the object. Moreover, because most tools are substantially rigid, various embodiments can be used to take measurements in situations in which a conventional tape measure proves too flimsy/flexible. Also, because many tools are narrower than conventional tape measures and straight rules, various embodiments may be used to measure depths in spaces in which conventional tape measures and straight rules cannot.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A tool comprising:
an elongated surface having a plurality of spaced markings thereon for enabling a user of said tool to measure a length of an object or a depth by comparing said length of said object to said spaced markings.

2. The tool as recited in claim 1, wherein said tool comprises a wrench.

3. The tool as recited in claim 2, wherein said tool comprises a handle, and wherein said handle includes said surface.

4. The tool as recited in claim 1, wherein said tool comprises an adjustable wrench.

5. The tool as recited in claim 4, wherein said tool comprises a handle, and wherein said handle includes said surface.

6. The tool as recited in claim 1, wherein said tool comprises a ratchet.

7. The tool as recited in claim 6, wherein said tool comprises a handle, and wherein said handle includes said surface.

8. The tool as recited in claim 1, wherein said tool comprises a pliers.

9. The tool as recited in claim 8, wherein said pliers comprises a pair of handles and a pair of jaws, wherein further at least one of said jaws includes said surface.

10. The tool as recited in claim 1, wherein said tool comprises a screwdriver.

11. The tool as recited in claim 10, wherein said screwdriver comprises a handle portion and a shaft portion, and wherein further said shaft portion includes said surface.

12. The tool as recited in claim 1, wherein said tool comprises a socket.

13. The tool as recited in claim 12, wherein said elongated surface is an outward-facing surface of said socket.

14. The tool as recited in claim 1, wherein said tool comprises a hammer.

15. The tool as recited in claim 14, wherein said tool comprises a handle, and wherein said handle includes said surface.
